(19) United States
(12) Patent Application Publication
(10) Pub. No.: US 2021/0392548 A1
(43) Pub. Date: Dec. 16, 2021

(54) Network Bandwidth Throttling Detection and Dynamic Buffer Threshold Selection

(71) Applicant: Apple Inc., Cupertino, CA (US)

(72) Inventors: Raghuveer Mallikarjunan, Sunnyvale, CA (US); Madhusudan Chaudary, Campbell, CA (US); Faraz Faheem, Santa Clara, CA (US); Rajesh Ambati, Los Altos Hills, CA (US); Ajay Singh, San Jose, CA (US); Muhammad A. Alam, San Jose, CA (US); Muthukumaran Dhanapal, Dublin, CA (US); Geoffrey R. Hall, San Jose, CA (US); Franco Travostino, San Jose, CA (US); Thanigaivelu Elangovan, Santa Clara, CA (US); Lakshmi N. Kavuri, Cupertino, CA (US); John Y. Su, Sunnyvale, CA (US); Ajoy K. Singh, Milpitas, CA (US); Punit H. Awatramani, Cupertino, CA (US); Arun G. Mathias, Los Altos, CA (US); Jordan B. Schneider, Cupertino, CA (US); Roger N. Pantos, Cupertino, CA (US); Alan Tseng, Sanratoga, CA (US)

(21) Appl. No.: 16/902,095

(22) Filed: Jun. 15, 2020

(51) Int. Cl. H04W 28/20; H04W 28/02; H04W 24/08

(52) U.S. Cl. CPC H04W 28/20; H04W 28/0257; H04W 24/08; H04W 28/0278

(57) ABSTRACT

This disclosure relates to techniques for a wireless device to detect network bandwidth throttling and dynamically select a buffer threshold. The wireless device may establish a wireless link. Data for a downlink stream may be requested when an amount of buffered data for the stream is below a lower buffer threshold, received via the wireless link, and buffered. Data requests for the stream may be stopped when the amount of buffered data for the stream is above an upper buffer threshold. The upper buffer threshold may be selected based on characteristics of the wireless link and the stream. Throughput of the wireless link may also be monitored during multiple time windows, and the wireless device may determine whether the wireless link caps bandwidth below a bandwidth threshold based on the throughput monitoring.

### FIELD

The present application relates to wireless communications, and more particularly to systems, apparatuses, and methods for detecting network bandwidth throttling and dynamically selecting a buffer threshold in a wireless device.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is important to reduce power requirements while allowing the UE device to maintain good transmit and receive abilities for improved communications. Accordingly, improvements in the field are desired.

### SUMMARY

Embodiments are presented herein of apparatuses, systems, and methods for detecting network bandwidth throttling and dynamically selecting a buffer threshold in a wireless device.

According to the techniques described herein, a wireless device may implement a stream buffering approach that includes use of a (e.g., lower) buffer threshold used to determine when to request data for the stream and a (e.g., upper) buffer threshold used to determine when to stop requesting data for the stream. The lower buffer threshold may be selected such as to attempt to maintain a sufficient buffer to ensure smooth stream playback, while the upper buffer threshold may be selected such as to attempt to operate efficiently with respect to power consumption and data usage within the device capabilities in order to provide a good user experience, at least according to some embodiments. Either or both may be selected dynamically based on any of a variety of considerations.

In some instances, the upper buffer threshold may be selected dynamically based at least in part on characteristics of a wireless link used to receive the stream. For example, for a wireless link that can provide relatively high bandwidth at a relatively high power consumption cost, the wireless device may select a larger upper buffer threshold, e.g., in order to facilitate longer possible idle time between bursts of downlink data reception for the stream, which may reduce the power consumed by the wireless device in comparison to use of a smaller upper buffer threshold. In contrast, for a wireless link with a lower bandwidth capability, the wireless device may select a smaller upper buffer threshold, e.g., to reduce the amount of excess stream data buffered, which may reduce the power consumption and data usage of the wireless device in scenarios in which the stream is interrupted (e.g., by a user) prior to completion. According to various embodiments, the upper buffer threshold may additionally or alternatively be dynamically selected based at least in part on stream characteristics, such as stream bitrate and/or stream active time, device capabilities (e.g., memory/storage capabilities), etc.

In some instances, the wireless device may also or alternatively assess the wireless link used for the stream for a possible bandwidth cap, e.g., such as may be imposed by a wireless network operator, for example based on monitoring the throughput of the wireless link during each of a set of time windows. The presence of a bandwidth cap on the wireless link may affect the buffer threshold selection by the wireless device directly, and/or may trigger the wireless device to switch to a different wireless link (e.g., that operates according to a different radio access technology that can provide a similar bandwidth at a lower cost, or that operates according to the same radio access technology but is not subject to a bandwidth cap), among various possibilities.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a flowchart diagram illustrating aspects of an exemplary possible method for detecting network bandwidth throttling and dynamically selecting a buffer threshold in a wireless device, according to some embodiments;

FIGS. 6-7 are timing diagrams illustrating possible operating profiles for different possible stream buffering approaches, according to some embodiments;

FIGS. 8-9 are timing diagrams illustrating possible operating profiles for rate capped and non rate capped streaming, according to some embodiments;

FIGS. 10-11 illustrate various possible example test results indicating whether various streaming apps are subject to bandwidth caps via various cellular carriers and Wi-Fi, according to some embodiments;

FIGS. 12-14 are timeline diagrams illustrating various possible example media streaming process activity profiles for various scenarios, according to some embodiments; and

FIGS. 15-16 illustrate aspects of a possible rate capping detection mechanism based on measuring stream throughput over multiple time windows, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
TRP: Transmission-Reception-Point

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

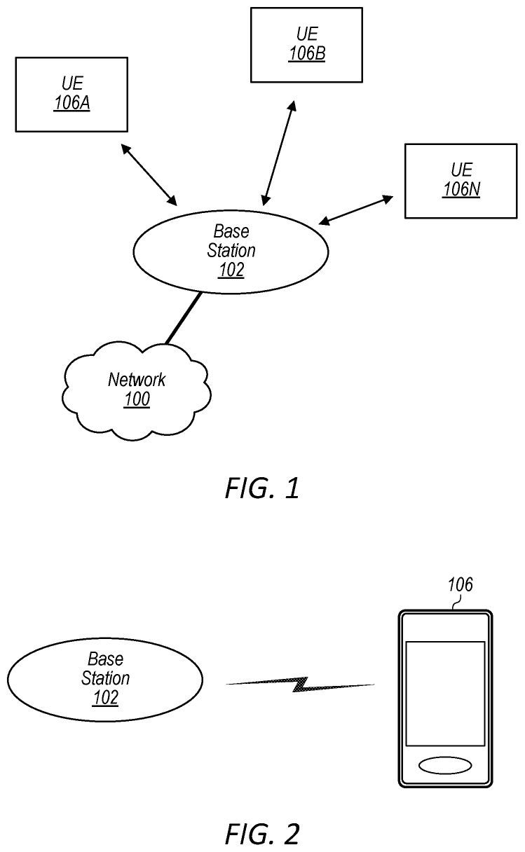

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to predict and mitigate thermal pressure in a wireless device, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH′. Other configurations are also possible.

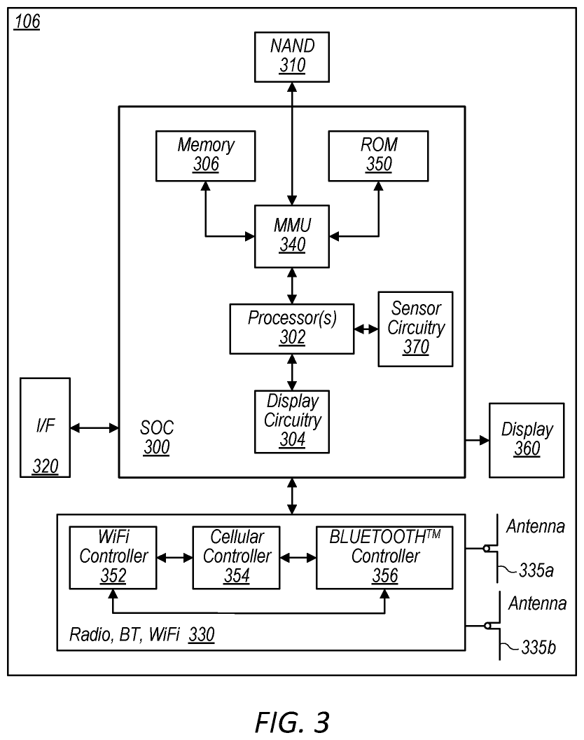

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH′, Wi-Fi, GPS, etc.). The UE device 106 may include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. As noted above, the UE may be configured to communicate wirelessly using multiple wireless communication standards in some embodiments.

The UE 106 may include hardware and software components for implementing methods for the UE 106 to detect network bandwidth throttling and/or dynamically select a buffer threshold in a wireless device, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to detect network bandwidth throttling and/or dynamically select a buffer threshold in a wireless device according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g. LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

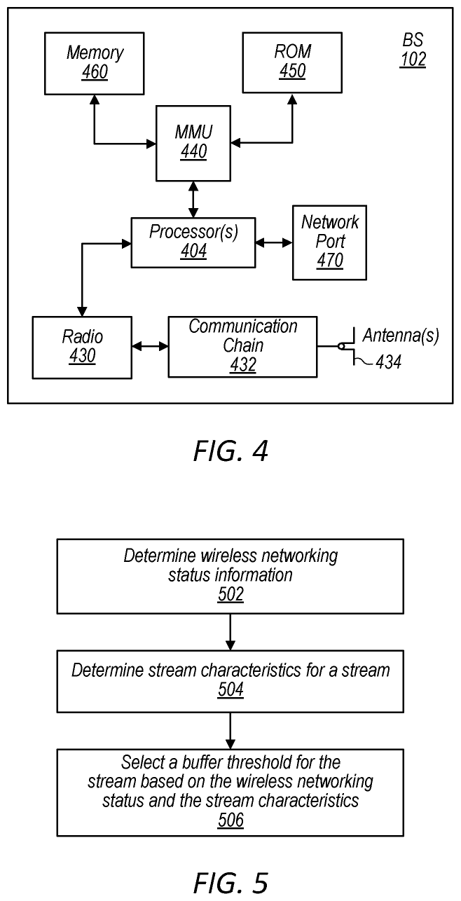

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, NR, LTE, LTE-A WCDMA, CDMA2000, etc. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network (s), e.g., it may include at least one Ethernet port, and radio 430 may be designed to communicate according to the Wi-Fi standard.

### FIG. 5-16—Network Bandwidth Throttling Detection and Dynamic Buffer Threshold Selection

Different wireless communication technologies can have significant variation in their features and performance. For example, at least in some instances, 3GPP 5G NR cellular communication technology may support communication with higher data rates than previous cellular communication technologies, albeit potentially at a higher power cost. As one possibility, in the case of media (e.g., video, audio, or audiovisual) streaming, this may mean that improved streaming resolution can be obtained, but that frequent buffering could increase power consumption. Note that the term ‘streaming’, as used herein, has the full breadth of its ordinary meaning, and at least includes provision of content in such a manner that presentation of the content can begin before the entirety of the content has been provided.

One possibility for mitigating such potential for increased power consumption may include modifying the buffering behavior of a wireless device, e.g., depending on the characteristics of its data link, and/or based on any of various other possible considerations. For example, it may be possible to dynamically configure the buffering thresholds for a wireless device such that a relatively large amount of stream data can be received and buffered in a short amount of time when using a high bandwidth link, such as at least some 3GPP 5G NR cellular links, and such that the wireless device may be able to operate in a reduced power consumption (e.g., idle) mode for a relatively long period of time between such buffering bursts.

However, as another consideration, in some instances it may be the case that a cellular network can implement a bandwidth cap (e.g., in general, or for certain applications such as video streaming, or for certain devices (e.g., based on data plan and data usage), among various possibilities) on a cellular link, which could negate at least some of the benefits of such a dynamic buffer threshold selection technique. Thus, it may also be beneficial, at least in some instances, for a wireless device to implement techniques to detect when network bandwidth throttling is occurring, and possibly to modify its wireless communication configuration in response to such network bandwidth throttling.

Accordingly, FIG. 5 is a flowchart diagram illustrating such a method for detecting network bandwidth throttling and dynamically selecting a buffer threshold in a wireless device, at least according to some embodiments. Aspects of the method of FIG. 5 may be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

In 502, the wireless device may determine wireless networking status information for the wireless device. The wireless networking status information may include any of various possible information, such as various characteristics of a wireless link of the wireless device. As one possibility, the wireless networking information may include information indicating a wireless communication technology/radio access technology according to which the wireless device has network connectivity, such as whether the wireless device has a wireless link according to NR, LTE, Wi-Fi, etc. In some instances, the wireless link characteristics could additionally or alternatively include a frequency band of the wireless link, and/or a carrier (e.g., network operator) associated with the wireless link. As another possibility, the wireless networking information may include information indicating whether such a wireless link is subject to a bandwidth cap.

For example, in some instances, the wireless device may determine whether the wireless link is subject to a bandwidth cap, and/or whether the wireless link caps bandwidth below a certain bandwidth threshold. This may include monitoring throughput of the wireless link during multiple time windows (which may be any of various possible lengths, e.g., 200 ms, 500 ms, is, 2s, etc.), e.g., while a stream is active. At least as one possibility, the bandwidth threshold may be selected such that if the bandwidth is capped below the bandwidth threshold, it may be the case that stream data is received in most such windows, and the bandwidth in each such window is below the bandwidth threshold. In contrast, if the bandwidth is not capped below the bandwidth threshold, it may be the case that stream data is only received in some windows, and that those windows have bandwidth above the bandwidth threshold. Thus, the wireless device may be able to determine whether the wireless link caps bandwidth below the selected bandwidth threshold, e.g., depending on the throughput of the wireless link during each of the time windows monitored by the wireless device. Note that in some instances, the monitored time windows may begin at a certain interval after a stream becomes active, or otherwise extend for a certain length of time after the stream becomes active, e.g., in case a wireless network operator does not begin bandwidth throttling for the stream until after a certain amount of time has passed since the stream began, or for any of various other possible reasons.

In some instances, the wireless device may re-select to a different wireless link (e.g., may establish a second wireless link), e.g., that operates according to a different radio access technology and/or that may not be subject to a bandwidth cap, if it is determined that the wireless link is subject to a bandwidth cap (and/or possibly depending on the size of the bandwidth cap), and may receive and buffer data for the stream via the second wireless link. For example, if the wireless link is a rate-capped NR link, the wireless device may determine that a LTE link may be more power efficient and provide similar bandwidth, and so may switch to the LTE link.

In 504, the wireless device may determine stream characteristics for a stream that the wireless device is configured to receive. The stream characteristics may include any of various possible characteristics. As one possibility, the stream characteristics may include a bitrate (e.g., 550 kbps, 2 Mbps, 9 Mbps, etc.) of the stream. As another possibility, the stream characteristics may include an amount of time for which the stream has been active. Such an amount of time may include an amount of time that the stream has been active without seeking or other interruptions, and/or may include a total amount of time that the stream has been active, among various possibilities.

In 506, the wireless device may select one or more buffer thresholds for the stream, based at least in part on the wireless networking status information and/or the stream characteristics for the stream. The buffer threshold(s) may be used to determine when to request data for the stream, and when to halt such data requests for the stream, e.g., in order to balance various considerations such as maintaining a sufficient amount of buffered data for smooth playback of the stream, operating in a power consumption efficient manner to support longer battery life, and operating within the configured storage/memory capacity of the wireless device.

In some instances, the buffer threshold(s) for the stream may include a lower buffer threshold and an upper buffer threshold. The lower buffer threshold may be used to determine when to request data for the stream. For example, the wireless device may be configured to request data for the stream when the amount of buffered data for the stream is below the lower buffer threshold. In some instances, the lower buffer threshold may be configured as an amount of data that provides a certain amount of playback time for the stream (e.g., based on the stream bitrate), such as 10 s, 30 s, 50 s, 60 s, etc. Alternatively, the lower buffer threshold may be configured directly as an amount of data, if desired. Thus, when the stream is initiated, and the amount of buffered data for the stream is below the lower buffer threshold (e.g., at 0 s/0 bytes), the wireless device may begin requesting data for the stream.

The upper buffer threshold may be used to determine when to stop (or pause) requesting data for the stream. For example, the wireless device may be configured to stop requesting data for the stream when the amount of buffered data for the stream is above the upper buffer threshold. In some instances, the upper buffer threshold may also be configured as an amount of data that provides a certain amount of playback time for the stream, such as 60 s, 80 s, 110 s, 300 s, etc. Alternatively, the upper buffer threshold may be configured directly as an amount of data, if desired. The upper buffer threshold may be greater than the lower buffer threshold, e.g., to provide hysteresis, at least in some embodiments. Thus, after the amount of buffered data for the stream rises above the upper buffer threshold, as playback of the stream occurs, the amount of buffered data for the stream may eventually fall below the lower buffer threshold, and the wireless device may resume requesting data for the stream, e.g., until the amount of buffered data for the stream again rises above the upper buffer threshold.

By dynamically selecting the buffer threshold(s), the difference between the upper buffer threshold and the lower buffer threshold, and thus the amount of stream data typically received by the wireless device in a given buffering burst, may be selected in such a manner that accounts for the different characteristics of different wireless links and different streams, and potentially that also accounts for memory/storage characteristics of the wireless device, to potentially provide better overall performance in view of those characteristics.

In some instances, it may be beneficial to select a larger upper buffer threshold if the wireless link operates according to one radio access technology (e.g., NR) than another radio access technology (e.g., LTE), e.g., depending on an expected throughput or bandwidth of those radio access technologies. For example, it may be the case that a larger upper buffer threshold is selected for a radio access technology with a higher expected throughput or bandwidth than for a radio access technology with a lower expected throughput or bandwidth. In various embodiments, such dynamic selection may additionally or alternatively be based on a frequency band of the wireless link (e.g., different frequency bands may be expected to provide different bandwidth and/or have different power consumption profiles), whether the wireless link is bandwidth capped (and/or what the bandwidth cap of the wireless link is), and/or a carrier or network operator associated with the wireless link (e.g., some carriers may have different known bandwidth capping behaviors and/or other characteristics than others).

As another example, in some instances, it may be beneficial to select a larger upper buffer threshold if the stream has been active for an amount of time greater than a time threshold than if the stream has been active for an amount of time less than the time threshold. For example, if a user has been watching a video stream for only a short amount of time, there may be a higher likelihood that the user may stop watching the video stream than if the user has been watching the video stream for a longer amount of time. Accordingly, waiting to increase the upper buffer threshold until after a stream has been active for a certain amount of time may decrease the amount of data that is unnecessarily requested and buffered in case the stream is interrupted prior to completion.

As another possibility, in some instances, the upper buffer threshold may be selected based at least in part on the bitrate of the stream and/or an amount of memory allocated to stream buffering (e.g., one or more data storage limits, which may be configured on a per stream basis and/or for all streams) by the wireless device. For example, for a high bitrate stream, it may be possible that the upper buffer threshold is limited by the amount of data that can be stored within a configured data storage limit (e.g., 64 MB, 96 MB, 128 MB, etc.) for the stream. For a lower bitrate stream, it may be possible that the upper buffer threshold is instead limited to an amount of data corresponding to a certain amount of playback time for the stream, e.g., even if such an amount of data is less than the configured data storage limit for the stream. Alternatively, it may be the case that the upper buffer threshold can approach or be as large as the configured data storage limit for a stream even for a lower bitrate stream (e.g., which may result in it being possible to buffer an amount of data corresponding to a larger amount of playback time for the stream than for a higher bitrate stream), if desired. As a still further possibility, it may be the case that a data storage limit is not configured for the stream, or that the upper buffer threshold is not based on the data storage limit for the stream, but instead is always selected to correspond to an amount of data corresponding to a certain amount of playback time for the stream, e.g., based on the bitrate of the stream, if desired.

Note that it may be possible for the characteristics of the wireless link and/or the stream to change over time. For example, the amount of time for which the stream has been active may generally increase over time. As another example, if the wireless device experiences mobility, the characteristics of the wireless link may change (e.g., handover or re-selection to a new cell in a different frequency band or that operates according to a different radio access technology may occur, etc.). Such changes may trigger the wireless device to change the buffer threshold(s) previously selected for the stream, e.g., based on the updated wireless link characteristics and/or stream characteristics.

Thus, the method of FIG. 5 may be used to detect network bandwidth throttling and to dynamically select a buffer threshold in a wireless device. At least according to some embodiments, such techniques may help reduce device power consumption, e.g., by improving the data per power consumption rate, and/or otherwise improve user experience, at least in some instances.

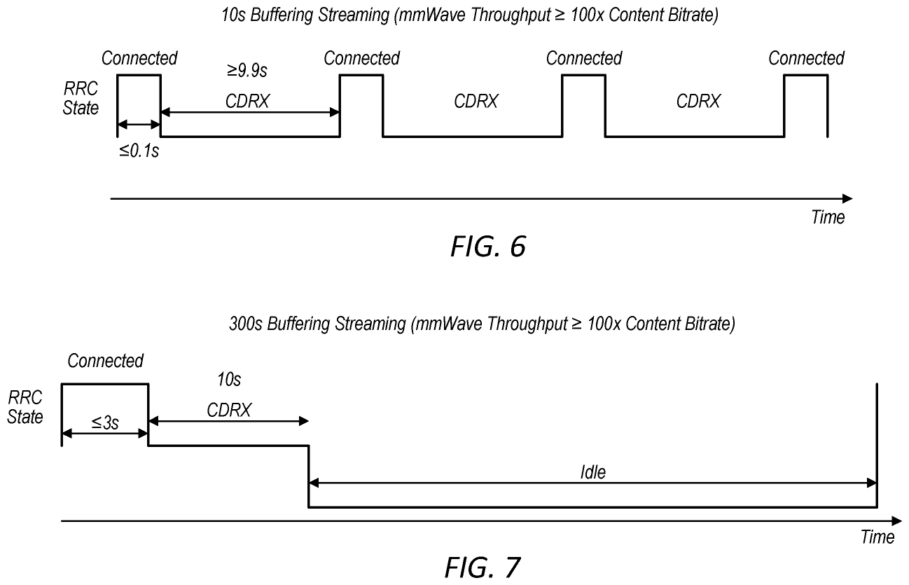

FIGS. 6-16 illustrate further aspects that might be used in conjunction with the method of FIG. 5 if desired. It should be noted, however, that the exemplary details illustrated in and described with respect to FIGS. 6-16 are not intended to be limiting to the disclosure as a whole: numerous variations and alternatives to the details provided herein below are possible and should be considered within the scope of the disclosure.

FIGS. 6-7 are timing diagrams illustrating possible operating profiles for different possible stream buffering approaches, according to some embodiments. In particular, FIG. 6 illustrates aspects of a possible scenario in which the difference between the lower buffer threshold and the upper buffer threshold for a stream is equivalent to 10 s of stream data, and a 5G NR mmWave wireless link with a throughput at least equal to 100 times the content bitrate is used to receive the stream. In this scenario, as shown, the wireless device may potentially spend alternating periods of ≤0.1 s in an RRC connected state (e.g., to receive bursts of stream data) and ≥9.9 s in a connected discontinuous reception (CDRX) state.

In contrast, FIG. 7 illustrates aspects of a possible scenario in which the difference between the lower buffer threshold and the upper buffer threshold for a stream is equivalent to 300 s of stream data, and a 5G NR mmWave wireless link with a throughput at least equal to 100 times the content bitrate is used to receive the stream. In this scenario, as shown, the wireless device may potentially spend a period of ≤3 s in an RRC connected state (e.g., to receive bursts of stream data), 10 s in a connected discontinuous reception (CDRX) state, and ≥287 s in an idle state. Thus, for an approximately equivalent amount of stream buffering, significantly more time may be spent by the wireless device in the lower power consumption idle state in the scenario of FIG. 7 than in the scenario of FIG. 6, potentially corresponding to a significantly reduced overall power consumption by the wireless device for a similar stream bitrate.

While such use of a relatively large difference between the lower buffer threshold and the upper buffer threshold for a stream may result in reduced power consumption for similar amounts of data buffered, at least in certain scenarios, there may also be reasons to limit the upper buffer threshold for a stream, such as device memory or storage limitations. For example, particularly for high bitrate streams, it may be the case that using a relatively large upper buffer threshold may have a correspondingly large memory use cost. Thus, in some instances, selection of an upper buffer threshold for a stream may be subject to an absolute memory cap, e.g., to balance memory footprint requirements for streaming with the aforementioned power consumption considerations.

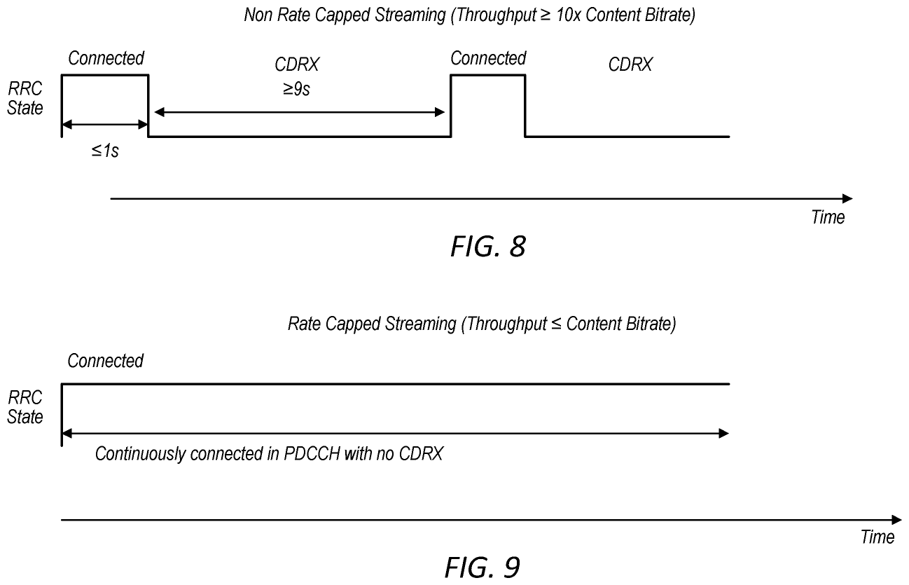

FIGS. 8-9 are timing diagrams illustrating possible operating profiles for rate capped and non rate capped streaming, according to some embodiments. In particular, in the non rate capped streaming scenario illustrated in FIG. 8, throughput may be at least equal to 10 times the content bitrate of the stream, while in the rate capped scenario illustrated in FIG. 9, throughput may be limited to less than or equal to the content bitrate of the stream. As a result, in the non rate capped scenario, the wireless device may potentially spend alternating periods of ≤1 s in an RRC connected state and ≥9 s in a CDRX state, while in the rate capped scenario, the wireless device may remain continuously connected in RRC, e.g., in order to attempt to keep up with the content bitrate.

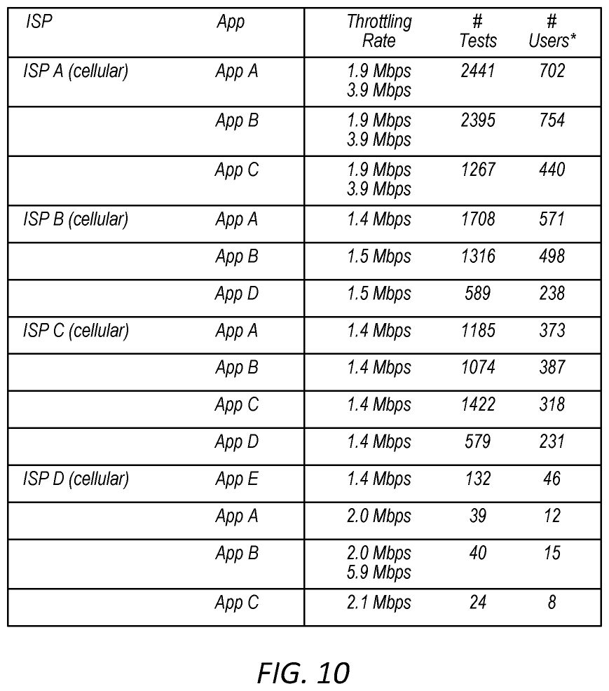

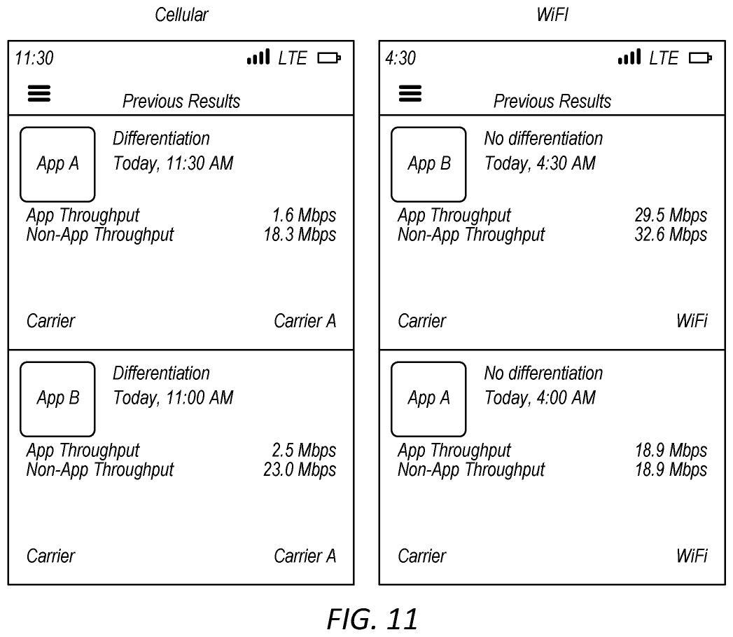

FIG. 10 illustrates possible example test results indicating whether various streaming apps are subject to bandwidth caps via a cellular carrier and via Wi-Fi, when tested for differentiation between throughput for each tested streaming app with other throughput. As shown, in the illustrated example, ‘App A’ and ‘App B’ may both be subject to rate capping via the cellular carrier, but not via Wi-Fi. FIG. 11 lists example throttling rate measurement results of similar differentiation type testing for various apps via various cellular carriers.

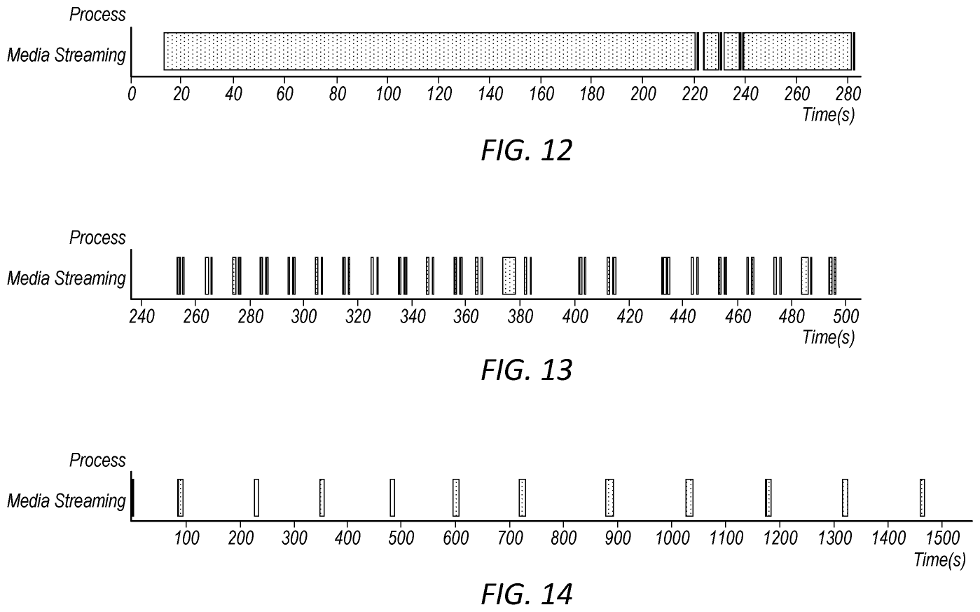

FIGS. 12-14 are timeline diagrams illustrating various possible example media streaming process activity profiles for various scenarios, according to some embodiments. FIG. 12 illustrates continuous media streaming process activity, such as may result when streaming is performed using a data link that is subject to bandwidth throttling that causes the wireless device to continuously remain connected. FIG. 13 illustrates periodic media streaming process activity, such as may result when streaming is performed using a data link that is not subject to bandwidth throttling, and in which a relatively small difference between a lower buffer threshold and an upper buffer threshold is configured. FIG. 14 illustrates periodic media streaming process activity, with longer periods of inactivity between each period of activity than in the scenario of FIG. 13, such as may result when streaming is performed using a data link that is not subject to bandwidth throttling, and in which a relatively large difference between a lower buffer threshold and an upper buffer threshold is configured.

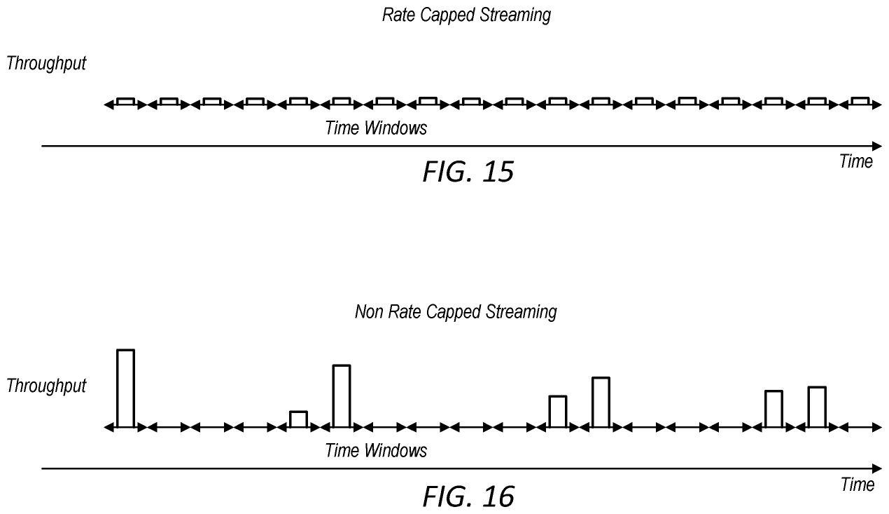

As previously described herein, it may be possible to make use of the difference in operating profile of a wireless device depending on whether a rate cap is in place to detect whether a rate cap is in place. FIGS. 15-16 illustrate aspects of one such possible detection mechanism. As shown, in each of multiple time windows while a stream is active, the throughput of a wireless link used to receive the stream may be measured by the wireless device. In a rate capped scenario, such as illustrated in FIG. 15, there may be throughput in most or all of the time windows, and the throughput may be limited below a certain threshold by the bandwidth cap in each of the time windows. In contrast, in a non rate capped scenario, such as illustrated in FIG. 16, there may be throughput in some time windows, but not in other time windows, and the throughput during the time windows when data requests are made may be significantly higher than in the rate capped scenario. Thus, it may be possible for the wireless device to determine whether a rate cap is in place (and possibly what the rate cap is), e.g., based on any of all of a proportion of time windows with throughput, the variation in throughput between different time windows, the highest throughput measured in any of the time windows, and or any of various other possible measures, using such an approach.

At least in some instances, it may be the case that the techniques described herein may be used by a wireless device to improve the power consumption efficiency of streaming via a 5G NR wireless link, potentially such that it may be possible to support a higher stream bitrate via the 5G NR wireless link than via a LTE wireless link at a similar power consumption cost, and/or to support a similar stream bitrate via the 5G NR wireless link as via a LTE wireless link at a lower power consumption cost.

In the following further exemplary embodiments are provided.

One set of embodiments may include an apparatus, comprising: a processor configured to cause a wireless device to: determine wireless networking status information for the wireless device; determine one or more stream characteristics for a stream that the wireless device is configured to receive via wireless communication; select an upper buffer threshold for the stream based at least in part on the wireless networking status information and the one or more stream characteristics for the stream; request data for the stream when an amount of buffered data for the media stream is below a lower buffer threshold for the stream; and stop requesting data for the stream when an amount of buffered data for the media stream is above the upper buffer threshold for the stream.

According to some embodiments, the wireless networking status information includes information indicating a wireless communication technology according to which the wireless device has network connectivity.

According to some embodiments, the wireless networking status information includes information indicating whether a wireless link of the wireless device is subject to a bandwidth cap.

According to some embodiments, the processor is further configured to cause the wireless device to: monitor throughput of a first wireless link of the wireless device during a plurality of time windows; determine, based at least in part on the throughput of the first wireless link during the plurality of time windows, whether the first wireless link is subject to a bandwidth cap.

According to some embodiments, the processor is further configured to cause the wireless device to: re-select to a second wireless link based at least in part on the first wireless link being subject to a bandwidth cap, wherein the second wireless link operates according to a different wireless communication technology than the first wireless link.

According to some embodiments, the one or more stream characteristics include a bitrate of the stream.

According to some embodiments, the one or more stream characteristics include an amount of time for which the stream has been active.

According to some embodiments, the processor is further configured to cause the wireless device to: determine that a wireless networking status and/or one or more stream characteristics have changed; and modify the upper buffer threshold for the stream based at least in part on the wireless networking status and/or one or more stream characteristics having changed.

Another set of embodiments may include a wireless device, comprising: an antenna; a radio operably coupled to the antenna; and a processor operably coupled to the radio; wherein the wireless device is configured to: establish a wireless link; receive and buffer data for a media stream via the wireless link, wherein the wireless device is configured to request data for the media stream when an amount of buffered data for the media stream is below a first buffer threshold for the media stream and stop requesting data for the media stream when the amount of buffered data for the media stream is above a second buffer threshold for the media stream; and select the second buffer threshold for the media stream based at least in part on one or more characteristics of the wireless link and/or one or more stream characteristics of the media stream.

According to some embodiments, the wireless device is further configured to: determine that one or more characteristics of the wireless link and/or one or more stream characteristics of the media stream have changed; and modify the second buffer threshold for the media stream based at least in part on one or more characteristics of the wireless link and/or one or more stream characteristics of the media stream having changed.

According to some embodiments, the wireless device is further configured to: select the first buffer threshold for the media stream based at least in part on one or more characteristics of the wireless link and/or one or more stream characteristics of the media stream.

According to some embodiments, wherein the one or more characteristics of the wireless link include one or more of: a radio access technology of the wireless link; a frequency band of the wireless link; a carrier of the wireless link; or a bandwidth cap of the wireless link.

According to some embodiments, the one or more stream characteristics of the media stream include one or more of: a bitrate of the media stream; or an amount of time for which the media stream has been active.

According to some embodiments, the second buffer threshold for the media stream is further selected based at least in part on a configured data storage limit for the media stream.

Yet another set of embodiments may include a method, comprising: by a wireless device: establishing a wireless link; requesting data for a downlink stream when an amount of buffered data for the downlink stream is below a first buffer threshold; receiving and buffering data for the downlink stream via the wireless link; stopping data requests for the downlink stream when the amount of buffered data for the downlink stream is above a second buffer threshold; and selecting the second buffer threshold based at least in part on one or more characteristics of the wireless link and one or more stream characteristics for the downlink stream.

According to some embodiments, the method further comprises: selecting a larger second buffer threshold if the wireless link operates according to a first radio access technology than if the wireless link operates according to a second radio access technology.

According to some embodiments, the method further comprises: selecting a larger second buffer threshold if the downlink stream has been active for an amount of time greater than a time threshold than if the downlink stream has been active for an amount of time less than the time threshold.

According to some embodiments, the method further comprises: selecting the second buffer threshold based at least in part on a bitrate of the downlink stream.

According to some embodiments, the method further comprises: monitoring throughput of the wireless link during a plurality of time windows; and determining whether the wireless link caps bandwidth below a bandwidth threshold based at least in part on the throughput of the wireless link during the plurality of time windows.

According to some embodiments, the method further comprises: establishing a second wireless link that operates according to a different radio access technology if it is determined that the wireless link caps bandwidth below the bandwidth threshold; and receiving and buffering data for the downlink stream via the second wireless link.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus, comprising:
a processor configured to cause a wireless device to:
determine wireless networking status information for the wireless device;
determine one or more stream characteristics for a stream that the wireless device is configured to receive via wireless communication;
select an upper buffer threshold for the stream based at least in part on the wireless networking status information and the one or more stream characteristics for the stream;
request data for the stream when an amount of buffered data for the media stream is below a lower buffer threshold for the stream; and
stop requesting data for the stream when an amount of buffered data for the media stream is above the upper buffer threshold for the stream.

2. The apparatus of claim 1,
wherein the wireless networking status information includes information indicating a wireless communication technology according to which the wireless device has network connectivity.

3. The apparatus of claim 1,
wherein the wireless networking status information includes information indicating whether a wireless link of the wireless device is subject to a bandwidth cap.

4. The apparatus of claim 1, wherein the processor is further configured to cause the wireless device to:
monitor throughput of a first wireless link of the wireless device during a plurality of time windows;
determine, based at least in part on the throughput of the first wireless link during the plurality of time windows, whether the first wireless link is subject to a bandwidth cap.

5. The apparatus of claim 4, wherein the processor is further configured to cause the wireless device to:
re-select to a second wireless link based at least in part on the first wireless link being subject to a bandwidth cap, wherein the second wireless link operates according to a different wireless communication technology than the first wireless link.

6. The apparatus of claim 1,
wherein the one or more stream characteristics include a bitrate of the stream.

7. The apparatus of claim 1,
wherein the one or more stream characteristics include an amount of time for which the stream has been active.

8. The apparatus of claim 1, wherein the processor is further configured to cause the wireless device to:
determine that a wireless networking status and/or one or more stream characteristics have changed; and
modify the upper buffer threshold for the stream based at least in part on the wireless networking status and/or one or more stream characteristics having changed.

9. A wireless device, comprising:
an antenna;
a radio operably coupled to the antenna; and
a processor operably coupled to the radio;
wherein the wireless device is configured to:
establish a wireless link;
receive and buffer data for a media stream via the wireless link, wherein the wireless device is configured to request data for the media stream when an amount of buffered data for the media stream is below a first buffer threshold for the media stream and stop requesting data for the media stream when the amount of buffered data for the media stream is above a second buffer threshold for the media stream; and
select the second buffer threshold for the media stream based at least in part on one or more characteristics of the wireless link and/or one or more stream characteristics of the media stream.

10. The wireless device of claim 9, wherein the wireless device is further configured to:
determine that one or more characteristics of the wireless link and/or one or more stream characteristics of the media stream have changed; and
modify the second buffer threshold for the media stream based at least in part on one or more characteristics of the wireless link and/or one or more stream characteristics of the media stream having changed.

11. The wireless device of claim 9, wherein the wireless device is further configured to:
select the first buffer threshold for the media stream based at least in part on one or more characteristics of the wireless link and/or one or more stream characteristics of the media stream.

12. The wireless device of claim 9,
wherein the one or more characteristics of the wireless link include one or more of:
a radio access technology of the wireless link;
a frequency band of the wireless link;
a carrier of the wireless link; or
a bandwidth cap of the wireless link.

13. The wireless device of claim 9,
wherein the one or more stream characteristics of the media stream include one or more of:
a bitrate of the media stream; or
an amount of time for which the media stream has been active.

14. The wireless device of claim 9,
wherein the second buffer threshold for the media stream is further selected based at least in part on a configured data storage limit for the media stream.

15. A method, comprising:
by a wireless device:
establishing a wireless link;
requesting data for a downlink stream when an amount of buffered data for the downlink stream is below a first buffer threshold;
receiving and buffering data for the downlink stream via the wireless link;
stopping data requests for the downlink stream when the amount of buffered data for the downlink stream is above a second buffer threshold; and
selecting the second buffer threshold based at least in part on one or more characteristics of the wireless link and one or more stream characteristics for the downlink stream.

16. The method of claim 15, wherein the method further comprises:
selecting a larger second buffer threshold if the wireless link operates according to a first radio access technology than if the wireless link operates according to a second radio access technology.

17. The method of claim 15, wherein the method further comprises:
selecting a larger second buffer threshold if the downlink stream has been active for an amount of time greater than a time threshold than if the downlink stream has been active for an amount of time less than the time threshold.

18. The method of claim 15, wherein the method further comprises:
selecting the second buffer threshold based at least in part on a bitrate of the downlink stream.

19. The method of claim 15, wherein the method further comprises:
monitoring throughput of the wireless link during a plurality of time windows; and
determining whether the wireless link caps bandwidth below a bandwidth threshold based at least in part on the throughput of the wireless link during the plurality of time windows.

20. The method of claim 18, wherein the method further comprises:
establishing a second wireless link that operates according to a different radio access technology if it is determined that the wireless link caps bandwidth below the bandwidth threshold; and
receiving and buffering data for the downlink stream via the second wireless link.
